(19) United States
(12) Patent Application Publication
(10) Pub. No.: US 2021/0354892 A1
(43) Pub. Date: Nov. 18, 2021

(54) MECHANICAL TYING APPARATUS

(71) Applicants: Sidney Ryan Clark, Prince George (CA); Colton Denby Clark, Vancouver (CA)

(72) Inventors: Sidney Ryan Clark, Prince George (CA); Colton Denby Clark, Vancouver (CA)

(21) Appl. No.: 17/242,197

(22) Filed: Apr. 27, 2021

Related U.S. Application Data
(60) Provisional application No. 63/025,941, filed on May 15, 2020.

(51) Int. Cl. B65D 63/10

(52) U.S. Cl. CPC B65D 63/1027; B65D 2563/101

(57) ABSTRACT

A securing apparatus that is configured to provide binding of items such as but not limited to cables. The securing apparatus includes first portion and a second portion that are configured to be operably coupled. The first portion includes a first end and a second end wherein the first end and the second end each have a retention member formed thereon. The second portion is provided is a roll wherein a section thereof is severed. Each end of the severed section of the second portion is operably coupled with the retention members present on the first portion. A loop is formed ensuing coupling of the second portion to the first portion wherein the loop can provide securing of items disposed therein. In a preferred embodiment of the present invention the first portion and second portion are manufactured from nylon.

### PRIORITY UNDER 35 U.S.C SECTION 119(E) & 37 C.F.R. SECTION 1.78

This nonprovisional application claims priority based upon the following prior U.S. Provisional Patent Application entitled: Mechanical Tying Apparatus, Application No. 63/025,941 filed May 15, 2020, in the name of Sidney Ryan Clark, which is hereby incorporated by reference for all purposes.

### FIELD OF THE INVENTION

The present invention relates generally to apparatus operable to tie items together such as but not limited to electrical wiring, more specifically but not by way of limitation, a securing apparatus that is configured to have a first portion and a second portion wherein the second portion is provided in a length from which a section is cut so as to be coupled to the first portion.

### BACKGROUND

A cable tie, also known as a zip tie is a type of securing apparatus for holding items together, primarily cables wires. Due to their low cost and ease of use cable ties are extremely common and used in a wide range of other applications. The common cable tie is normally made of nylon and has a flexible tape section with teeth on one surface that engage with a pawl in the head to form a ratchet so that as the free end of the tape section is pulled the cable tie tightens and does not come undone. Some ties include a tab that can be depressed to release the ratchet so that the tie can be loosened or removed, and possibly reused. Some are manufactured from materials such as but not limited to stainless steel coatings for use in hazardous environments.

The most common cable tie consists of a flexible nylon tape section with an integrated set of gear teeth and on one end a ratchet within a housing having a small opening. Once the pointed tip of the cable tie has been pulled through the case and past the ratchet, it is prevented from being pulled back through the housing. The resulting loop may only be pulled tighter. This allows several cables or wires to be bound together into a cable bundle. A cable tie tensioning device may be used to apply a cable tie with a specific degree of tension. The tool may cut off the extra tail flush with the head. One issue with current cable tie designs is the excessive amount of waste produced by removing the extra tail flush.

It is intended within the scope of the present invention to provide a tying apparatus similar to a conventional cable tie wherein the design of the present invention eliminates the production of excess tail flush.

### SUMMARY OF THE INVENTION

It is the object of the present invention to provide a cable securing apparatus that is operable to bind cable, electrical wires and other similar types of items wherein the present invention includes a first portion and a second portion.

Another object of the present invention is to provide a securing apparatus configured to provide securing of at least two items wherein the first portion is configured to be operably coupled with a section of the second portion.

A further object of the present invention is to provide a cable securing apparatus that is operable to bind cable, electrical wires and other similar types of items wherein the first portion includes a planar segment having a first end and a second end.

Still another object of the present invention is to provide a securing apparatus configured to provide securing of at least two items wherein the first portion includes a securing mechanism such as but not limited to a pawl, ratchet housing or metal tab integrally formed at both the first end and second end of the first member. In a preferred embodiment the securing mechanism includes a metal tab operable to engage a surface of the second portion.

An additional object of the present invention is to provide a cable securing apparatus that is operable to bind cable, electrical wires and other similar types of items wherein the first portion is manufactured from a flexible material such as but not limited to nylon.

Yet a further object of the present invention is to provide a securing apparatus configured to provide securing of at least two items wherein the first portion is provided in alternate lengths and strength ratings.

Another object of the present invention is to a provide a cable securing apparatus that is operable to bind cable, electrical wires and other similar types of items wherein the second portion is provided as a roll of flexible material such as but not limited to nylon.

An alternate object of the present invention is to provide a securing apparatus configured to provide securing of at least two items wherein the second portion is planar in manner and includes teeth formed on one surface thereof.

Still a further object of the present invention is to provide a cable securing apparatus that is operable to bind cable, electrical wires and other similar types of items wherein a section of the second portion that is required for a task is cut from a supplied roll of material.

An additional object of the present invention is to provide a securing apparatus configured to provide securing of at least two items wherein the opposing ends of the cut second portion are operably coupled with the pawls, ratchet housings or metal tabs at the first end and second end of the first portion.

An additional object of the present invention is to provide a cable securing apparatus that is operable to bind cable, electrical wires and other similar types of items wherein the design thereof eliminates any substantial production of a flush tail for subsequent removal.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an assembled embodiment of the present invention; and

FIG. 2 is a top view of an embodiment of the first portion of the present invention; and

FIG. 3 is a top view of an alternate embodiment of the first portion of the present invention; and

FIG. 4 is a side view of an embodiment of the first portion of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a securing apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

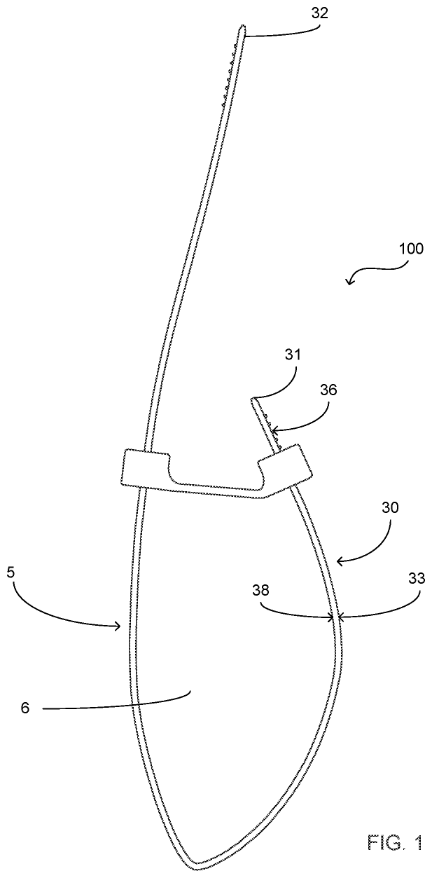

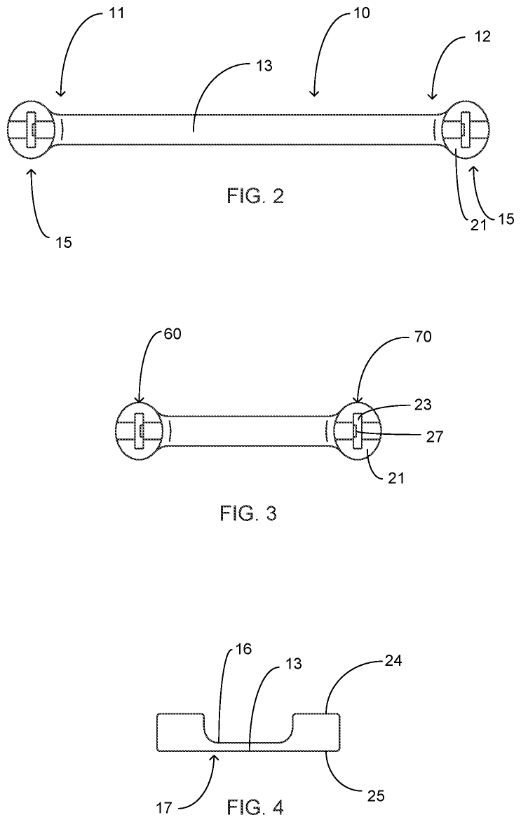

Referring now to the Figures submitted as a part hereof, the securing apparatus 100 includes a first portion 10 and a second portion 30. The first portion 10 and second portion 30 are configured to be operably coupled as illustrated herein in FIG. 1. As will be further discussed herein, the first portion 10 receives a length of the second portion 30 wherein the second portion 30 is secured within the retention members 15 present on the first portion 10 forming a loop 5 having void 6 wherein the items to be bound by the securing apparatus 100 are within the void 6 of the loop 5.

The first portion 10 includes a first end 11 and second end 12. The first portion 10 includes center section 13 wherein the center section 13 is planar in manner. The first portion 10 is manufactured from a suitable durable flexible material such as but not limited to nylon. The center section 13 in the preferred embodiment of the present invention can be manufactured in alternate lengths and widths in order to facilitate binding of different materials and further provide alternate load capacities. The center section 13 includes an upper surface 16 and a lower surface 17.

Formed on the first end 11 and second end 12 of the first portion 10 are retention members 15. The retention members 15 are configured to receive a section of the second portion 30 therethrough and provide securing thereof. The retention member 15 include a housing 21 wherein the housing 21 has a slot 23 formed therethrough extending completely from the front 24 to the rear 25. The slot 23 is sized so as to have a width that will allow a section of the second portion 30 to be journaled therethrough. It should be understood within the scope of the present invention that the slot 23 could be provided in alternate sizes in order to mateably accommodate a section of the second portion 30 having various thicknesses and widths. The slot 23 has formed therein a tab 27. Tab 27 is provided so as to engage the first surface 33 of the second portion 30. The tab 27 is biasly mounted so as to allow the second portion 30 to be inserted into the slot 23 yet inhibit the opposite motion. This ensures the desired binding of material within the loop 5. The toothed surface 33 while illustrated herein on only a section of the second portion 30 can be formed along the entire first surface 37 of the second portion 30. The aforementioned is the preferred embodiment as the second portion 30 is cut from a provided roll of second portion 30 so as to promote usage of only what is required for the securing tasks. While a preferred embodiment of the retention member 15 is illustrated and discussed herein, It is contemplated within the scope of the present invention that the retention member 15 could be a pawl, a ratchet housing or a alternate tab configuration that are operable to provide securing of the second portion 30 engaging therewith.

The second portion 30 includes a first end 31 and second end 32. Second portion 30 is planar in manner having a first surface 33 and a second surface 38. The first surface 33 in one embodiment includes teeth 36 formed thereon wherein the teeth 36 are operable to engage tab 27 so as to facilitate the securing of the second portion 30 with the retention member 15. It should be understood within the scope of the that the entire length of the first surface 33 could have teeth 36 formed thereon. The second portion 30 in a preferred embodiment is manufactured from nylon. The advantage of the present invention is to provide a second portion 30 in a length such as but not limited to five feet. A desired length is cut from the provided roll of second portion 30 so as to eliminate waste seen with conventional cable ties. The severed section of the second portion 30 is inserted into both the first retention member 60 and second retention member 70 forming the loop 5 that will bind the desired items therein as the second portion 30 is advanced into the first retention member 60 and second retention member 70.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A securing apparatus configured to provide binding of materials wherein the securing apparatus comprises:
a first portion, said first portion having a first end and a second end, said first portion having a center section, said center section extending intermediate said first end and said second end, said first end having a first retention member formed thereon, said second end having a second retention member formed thereon;
a second portion, said second portion being independent of said first portion, said second portion being planar in manner, said second portion configured to have a section thereof severed from a roll thereof, said section of said second portion operable to be mateably coupled with said first retention member and said second retention member so as to provide binding of the materials.

2. The securing apparatus as recited in claim 1, wherein said second portion includes a first surface and a second surface.

3. The securing apparatus as recited in claim 2, wherein the first surface of said second portion includes teeth formed thereon.

4. The securing apparatus as recited in claim 3, wherein said first retention member and said second retention member are selected from one of the following: pawl, ratchet housing or tab.

5. The securing apparatus as recited in claim 4, wherein the first portion and second portion are manufactured from nylon.

6. A securing apparatus configured to provide binding at least one cable or similar item wherein the securing apparatus comprises:
a first portion, said first portion having a first end and a second end, said first portion having a center section, said center section having an upper surface and a lower surface, said center section extending intermediate said first end and said second end, said first end having a first retention member formed thereon, said second end having a second retention member formed thereon, said first retention member and said second retention member being identically formed, said first retention member and said second retention member having a housing, said housing of said first retention member and said second retention member having a front wall and a rear wall, said housing of said first retention member and said second retention member having a slot, said slot of said first retention member and said second retention member extending through said housing from said front wall to said rear wall;
a second portion, said second portion being independent of said first portion, said second portion being planar in manner, said second portion having a first surface and a second surface, said second portion configured to have a section thereof severed from a roll thereof, said section of said second portion configured to be inserted into said slot of said first retention member and said second retention member.

7. The securing apparatus as recited in claim 6, wherein said first surface of said second portion has teeth formed thereon.

8. The securing apparatus as recited in claim 7, wherein said first retention member and said second retention member further include a tab, said tab present in said slot of said first retention member and said second retention member, said tab operable to engage said teeth in order to secure the severed section of said second portion in said first retention member and said second retention member.

9. The securing apparatus as recited in claim 8, wherein said first portion is provided in alternate lengths.

10. The securing apparatus as recited in claim 9, wherein said first portion and said second portion are manufactured from nylon.
